(19) United States
(12) Patent Application Publication
(10) Pub. No.: US 2008/0286689 A1
(43) Pub. Date: Nov. 20, 2008

(54) Antireflective Coating Compositions

(76) Inventors: Hong Zhuang, Raritan, NJ (US); Jianhui Shan, Pennington, NJ (US); Zhong Xiang, Edison, NJ (US); Hengpeng Wu, Hillsborough, NJ (US); Jian Yin, Bridgewater, NJ (US)

Correspondence Address: ALAN P. KASS;AZ ELECTRONIC MATERIALS USA CORP., 70 MEISTER AVENUE, SOMERVILLE, NJ, 08876, US

(21) Appl. No.: 11/747,936

(22) Filed: May 14, 2007

(51) Int. Cl. G03C 1/00

(52) U.S. Cl. 430/285.1; 430/270.1

(57) ABSTRACT

The present invention relates to antireflective coating compositions.

### FIELD OF THE INVENTION

This invention relates to the field of antireflective coatings and to a process for forming an image on a substrate using an antireflective coating composition.

### BACKGROUND OF THE INVENTION

In the production of semiconductor devices, an integrated circuit substrate is coated with a film of photo patterning resist, exposed to actinic radiation, and developed to define a resist image over the integrated circuit substrate. The resist image can, for example, include both lines and spaces, wherein portions of the photo patterning resist that are removed form the spaces and the portions that remain form the lines. The resist image is transferred to the integrated circuit substrate by modifying the exposed portion of the substrate. Such modification may be performed by removal of a portion of the substrate by etching processes, by implantation of atomic species into the substrate, or by other methods known to those skilled in the art. During such processes, the photo patterned resist lines act as a mask to prevent modification of the portions of the substrate underlying the resist lines. Resolution of the image transferred to the substrate is dependent on the resolution of the resist image.

During exposure of a photo patterning resist on an integrated circuit substrate, some reflection of the actinic radiation off the integrated circuit substrate will typically occur. The reflection causes film interference effects that change the effective exposure intensity within a chip, across the wafer, and from wafer to wafer. Given the variation in effective exposure intensity, an unacceptable amount of line width variation typically occurs. This is especially true in modern manufacturing where laser exposure tools are used as the source of the actinic radiation and reflection is particularly prevalent.

To prevent reflection of actinic radiation into a photo patterning resist, one or more layers of a bottom antireflective coating (BARC) may be provided between a substrate and a photo patterning resist film. BARC s often include a radiation adsorbing dye dispersed in a polymer binder, however, some polymers exist that contain an appropriate chromophore that sufficiently adsorbs the actinic radiation (i.e., the chromophore acts as the dye) such that an additional adsorbing dye is not required. The BARC may be adapted to attenuate a particular wavelength of radiation used to expose the photo patterning resist by a selection of suitable adsorbing dyes or a polymer having suitable chromophores.

The problems of critical dimension control caused by reflective substrates are far more serious in the ArF regime than in the longer wavelengths. It is therefore important to find a high performance antireflective coating layer working in this spectral regime. Furthermore, for increasing resolution of optical lithography, expose systems with high numerical aperture (NA) are essential. Those developments in current and future generation micro-lithography dictate, and more and more customers are requesting more precisely tailored BARC materials. The control of the substrate reflectivity by BARC is determined by three factors: the optical characteristics, i.e. refraction index (n) and absorption parameter (k) at exposure wavelength and BARC film thickness. The refraction index (n) and absorption parameter (k) determine properties such as optimal BARC thickness, minimum reflectivity of particular light incident angle, etc. Often, the desired n/k values can not be obtained with chromophores which are readily available or can be conveniently incorporated into the polymer material. The ability to manipulate the optical characteristics at exposure wavelength would allow the opportunities of using available chromophores which satisfy other criteria, such as etch rate, solubility and resist compatibility, but not optical parameter requirements.

For effective reflectivity reduction in current and future generation micro-lithography, BARCs need to exhibit precise optical parameters optimized for specific substrate stack and exposure conditions or for customer supplied specifications. Often times, it is not possible to achieve the precise optical parameters by using materials having a single chromophore or a single polymer. The inventors have developed BARC materials where the optical properties can be tuned or controlled to meet the specific needs of the customer or those determined for substrates using simulation techniques.

### SUMMARY OF THE INVENTION

The present invention relates to an antireflective coating composition capable of forming a film and suitable for coating over a substrate, the antireflective coating composition comprising a resin mixture, the resin mixture comprising at least a first resin and a second resin, where the amounts of the first resin and the second resin are tuned so that the film formed by the antireflective coating composition has an index of refraction (n) which is within ±0.1 of an index of refraction (n) required by a customer or determined by simulation and an absorption parameter (k) which is within ±0.02 of an absorption parameter (k) required by a customer or determined by simulation.

The invention also provides for a coated substrate comprising a substrate having thereon: a layer of the inventive composition and a layer of a chemically-amplified photoresist composition above the layer of the inventive composition. Also provided for in the invention is a method for forming a photoresist relief image comprising: applying on a substrate a layer of the inventive composition and applying a layer of chemically-amplified photoresist composition above the inventive composition. In addition, the invention provides a method for tuning an index of refraction (n) and an absorption parameter (k) of an antireflective coating composition capable of forming a film and suitable for coating over a substrate comprising obtaining index of refraction (n) and absorption parameter k) required by a customer or determined by simulation; obtaining at least a first resin; adding to said first resin a second resin to form the antireflective coating composition, the second resin being added in sufficient quantity so that the film formed by the antireflective coating composition has an index of refraction (n) which is within ±0.1 of the index of refraction (n) required by a customer or determined by simulation and an absorption parameter (k) which is within ±0.02 of the absorption parameter (k) required by a customer or determined by simulation.

### DETAILED DESCRIPTION OF THE INVENTION

The present invention relates to an antireflective coating composition capable of forming a film and suitable for coating over a substrate, the antireflective coating composition comprising a resin mixture, the resin mixture comprising at least a first resin and a second resin, where the amounts of the first resin and the second resin are tuned so that the film formed by the antireflective coating composition has an index of refraction (n) which is within ±0.1 of an index of refraction (n) required by a customer or determined by simulation and an absorption parameter (k) which is within ±0.02 of an absorption parameter (k) required by a customer or determined by simulation.

The invention also provides for a coated substrate comprising a substrate having thereon: a layer of the inventive composition and a layer of a chemically-amplified photoresist composition above the layer of the inventive composition. Also provided for in the invention is a method for forming a photoresist relief image comprising: applying on a substrate a layer of the inventive composition and applying a layer of chemically-amplified photoresist composition above the inventive composition. In addition, the invention provides a method for tuning an index of refraction (n) and an absorption parameter (k) of an antireflective coating composition capable of forming a film and suitable for coating over a substrate comprising obtaining index of refraction (n) and absorption parameter (k) required by a customer or determined by simulation; obtaining at least a first resin; adding to said first resin a second resin to form the antireflective coating composition, the second resin being added in sufficient quantity so that the film formed by the antireflective coating composition has an index of refraction (n) which is within ±0.1 of the index of refraction (n) required by a customer or determined by simulation and an absorption parameter (k) which is within ±0.02 of the absorption parameter (k) required by a customer or determined by simulation.

The antireflective coating composition is generally made up of at least two resins. The resins can be, for example, mixtures of polyester and polyether resins, two different polyester resins, or two different polyether resins, for example, where each different resin has, when a film is formed using the resin, different optical parameters. When a polyester resin is used as one or more of the resins in the antireflective coating composition, a crosslinking agent is typically also added to the composition, along with other additives well know to those skilled in the art. In addition, a chromophore can be added to the composition.

One class of polymers that is useful in forming the antireflective coating composition is a polyether polymer which is obtained by reacting at least one glycoluril compound with at least one reactive compound containing at least one hydroxy group and/or one acid group. One embodiment of this polymer is where the reactive compound comprises 2 or more hydroxy groups (polyhydroxy compound or polyol), a compound containing 2 or more acid groups (polyacid compound), or a hybrid compound containing both a hydroxy and an acid group. Another embodiment of this polymer is obtained by reacting at least one glycoluril compound with at least one reactive compound containing one hydroxy group or one acid group. In yet another embodiment, the polymer is obtained by reacting at least one glycoluril compound with a mixture comprising at least one reactive compound containing at least one hydroxy group or one acid group and at least one reactive compound comprising 2 or more hydroxy groups (polyhydroxy compound or polyol), a compound containing 2 or more acid groups (polyacid compound), or a hybrid compound containing both a hydroxy and an acid group. In all of the foregoing, a chromophore group which absorbs radiation can be present in the polymer.

The polyether polymer is formed from the condensation reaction of a reactive comonomer containing hydroxy groups and/or acid groups with a glycoluril compound. In the case of one embodiment, at least two reactive groups (hydroxy and/or acid) should be available in the comonomer which reacts with the glycoluril. The polymerization reaction may be catalyzed with an acid. In some instances, the glycoluril compound may condense with itself or with another polyol, polyacid or hybrid compound, and additionally, incorporate into the polymer a compound with one hydroxy and/or one acid group. Thus the polymer comprises monomeric units derived from glycoluril and reactive compounds containing a mixture of hydroxy and/or acid groups.

The glycoluril compounds are known and available commercially, and are further described in U.S. Pat. No. 4,064,191. Glycolurils are synthesized by reacting two moles of urea with one mole of glyoxal. The glycoluril can then be fully or partially methylolated with formaldehyde. A glycoluril compound containing the moiety of the general description as shown in Structure 1, is useful as a comonomer for the polymer of the present invention and becomes incorporated into the polymer.

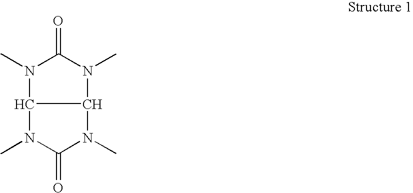

One type of glycouril comonomer useful in making the polymer has the Structure 2, where R₁, R₂, R₃, and R₄ are independently H or (C₁-C₁₀) alkyl.

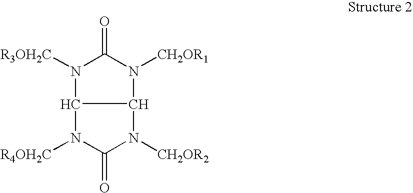

Examples of glycolurils include, for example, tetramethylol glycoluril, tetrabutoxymethyl glycoluril, tetramethoxymethyl glycoluril, partially methoylated glycoluril, tetramethoxymethyl glycoluril, dimethoxymethyl glycoluril, mono- and dimethylether of dimethylol glycoluril, trimethylether of tetramethylol glycoluril, tetramethylether of tetramethylol glycoluril, tetrakisethoxymethyl glycoluril, tetrakispropoxymethyl glycoluril, tetrakisbutoxymethyl glycoluril, tetrakisamyloxymethyl glycoluril, tetrakishexoxymethyl glycoluril, and the like. The glycoluril may also be in the form of an oligomer.

The polyhydroxy compound useful as the comonomer for polymerizing with the glycoluril may be a compound containing 2 or more hydroxyl groups or be able to provide 2 or more hydroxyl groups, such as diol, triol, tetrol, glycol, aromatic compounds with 2 or more hydroxyl groups, or polymers with end-capped hydroxyl groups or epoxide groups. More specifically, the polyhydroxy compound may be ethylene glycol, diethylene glycol, propylene glycol, neopentyl glycol, polyethylene glycol, styrene glycol, propylene oxide, ethylene oxide, butylene oxide, hexane diol, butane diol, 1-phenyl-1,2-ethanediol, 2-bromo-2-nitro-1,3-propane diol, 2-methyl-2-nitro-1,3-propanediol, diethylbis(hydroxymethyl)malonate, hydroquinone, and 3,6-dithia-1,8-octanediol. Further examples of aromatic diols are Bisphenol A, 2,6-bis(hydroxymethyl)-p-cresol and 2,2′-(1,2-phenylenedioxy)-diethanol, 1,4-benzenedimethanol, 2-benzyloxy-1,3-propanediol, 3-phenoxy-1,2-propanediol, 2,2′-biphenyldimethanol, 4-hydroxybenzyl alcohol, 1,2-benzenedimethanol, 2,2′-(o-phenylenedioxy)diethanol, 1,7-dihydroxynaphthalene, 1,5-naphthalenediol, 9,10-anthracenediol, 9,10-anthracenedimethanol, 2,7,9-anthracenetriol, other naphthyl diols and other anthracyl diols.

The polyacid compound useful as the reactive comonomer for polymerizing with the glycoluril may be a compound containing 2 or more acid groups or be able to provide 2 or more acidic groups, such as diacid, triacid, tetracid, anhydride, aromatic compounds with 2 or more acid groups, aromatic anhydrides, aromatic dianhydrides, or polymers with end-capped acid or anhydride groups. More specifically, the polyacid compound may be phenylsuccinic acid, benzylmalonic acid, 3-phenylglutaric acid 1,4-phenyldiacetic acid, oxalic acid, malonic acid, succinic acid, pyromellitic dianhydride, 3,3′,4,4′-benzophenone-tetracarboxylic dianhydride, naphthalene dianhydride, 2,3,6,7-naphthalenetetracarboxylic acid dianhydride and 1,4,5,8-naphthalenetetracarboxylic acid dianhydride, and anthracene diaacid.

Hybrid compounds containing a mixture of hydroxyl and acid groups may also function as comonomers, and may be exemplified by 3-hydroxyphenylacetic acid and 2-(4-hydroxyphenoxy)propionic acid.

The reactive comonomers, in addition to containing a hydroxyl and/or acid group, may also contain a radiation absorbing chromophore, where the chrompophore absorbs radiation in the range of about 450 nm to about 140 nm. In particular for antireflective coatings useful for imaging in the deep UV (250 nm to 140 nm), aromatic moieties are known to provide the desirable absorption characteristics. These chromophores may be aromatic or heteroaromatic moieties, examples of which are substituted or unsubstituted phenyl, substituted or unsubstituted naphthyl, and substituted or unsubstituted anthracyl. Typically, anthracyl moieties are useful for 248 nm exposure, and phenyl moieties are useful for 193 nm exposure. The aromatic groups may have pendant hydroxy and/or acid groups or groups capable of providing hydroxy or acid groups (e.g. epoxide or anhydride) either attached directly to the aromatic moiety or through other groups, where these hydroxy or acid groups provide the reaction site for the polymerization process. As an example, styrene glycol or an anthracene derivative, may be polymerized with a glycoluril of Structure 2.

In certain embodiments, the polyether polymer is essentially a condensation product of the glycoluril compound and further reacts with a monohydroxy and/or monoacid compound. The polymer may further comprise units derived from the monomers comprising multihydroxy groups, multiacid groups or mixture of hydroxyl and acid groups. The glycoluril compounds, multihydroxy groups, multiacid groups or mixture of hydroxy and acid groups are described previously in the application. The glycoluril compound selfcondenses to form a polymer and then further reacts with a monohydroxy compound to incorporate the chromophore.

Alternatively, the glycoluril compound reacts with a polyol, polyacid or hybrid compound to give a polymer which further reacts with the compound(s) containing the monofunctional hydroxy or monoacid group. The polymer may be used as the self-crosslinking polymer. Nonlimiting examples of the monohydroxy and monoacid compounds includes those which has a chromophoric group also, and examples of such compounds are phenol, o-cresol, 2-ethoxyphenol, p-methoxyphenol, m-cresol, 4-ethylphenol, 4-propylphenol, 4-fluorophenol, 2,3-dimethoxyphenol, 2,6-dimethylphenol, 2,4-dimethylphenol, 3,4,5-trimethylphenol, 1-naphthol, 2-naphthol, 4-methoxy-1-naphthol, 2-phenylphenol, 4-(benzyloxy)phenol, benzyl alcohol, 2-methylbenzyl alcohol, 2-methoxybenzyl alcohol, 3-methylbenzyl alcohol, 3-(trifluromethyl)benzyl alcohol, 4-ethylbenzyl alcohol, 4-ethoxybenzyl alcohol, 4-(trifluromethoxy)benzyl alcohol, 3,5-diflurobenzyl alcohol, 2,4,5-trimethoxybenzyl alcohol, 4-benzyloxybenzyl alcohol, 1-naphthalenethanol, 2-phenyl-1-propanol, 2,2-diphenylethanol, 4-phenyl-1-butanol, 2-phenoxyethanol, 4-methoxyphenethyl alcohol, 2-hydroxybenzophenone, phenylacetic acid, 1-naphthylacetic acid, etc.

The polyether polymer is synthesized by polymerizing the comonomers described previously. Typically, the desired glycoluril or mixtures of glycolurils is reacted with the reactive compound comprising polyol, polyacid, hybrid compound with acid and hydroxyl groups, reactive compound with one hydroxy group, reactive compound with one acid group or mixtures thereof, in the presence of a suitable acid. The polymer may be a linear polymer made with a glycoluril with 2 linking sites that are reacted or a network polymer where the glycoluril has more than 2 reactive sites connected to the polymer. Other comonomers may also be added to the reaction mixture and polymerized to give the polymer of the present invention. Strong acids, such as sulfonic acids can be used as a catalyst for the polymerization reaction. A suitable reaction temperature and time is selected to give a polymer with the desired physical properties, such as molecular weight. Typically the reaction temperature may range from about room temperature to about 150° C. and the reaction time may be from 20 minutes to about 24 hours. The weight average molecular weight (Mw) of the polymer is in the range of about 1,000 to about 50,000, further from about 3,000 to about 40,000, and more further from about 4,500 to about 40,000, and even more further from about 5,000 to about 35,000 for certain applications. When the weight average molecular weight is low, such as below 1,000, then good film forming properties are not obtained for the antireflective coating and when the weight average molecular weight is too high, then properties such as solubility, storage stability and the like may be compromised. However, lower molecular weight polymers used in the present invention can function well as crosslinking compounds in conjunction with another crosslinkable polymer, especially where the molecular weight of the lower molecular weight polymer ranges from about 500 to about 20,000, and further from about 800 to about 10,000.

Polymers of this type are further disclosed in U.S. patent application Ser. No. 10/941,221 filed Sep. 15, 2004, and Ser. No. 11/159,002, filed Jun. 22, 2005, the contents of both applications being hereby incorporated herein by reference.

Another polymer which can be used to form the antireflective coating composition is a polyester. These polymers are generally provided by polymerization of a carboxy-containing compound (such as a carboxylic acid, ester, anhydride, etc.) and a hydroxy-containing compound, such as a compound having multiple hydroxy groups such as a glycol, e.g. ethylene glycol or propylene glycol, or glycerol, or other diols, triols, tetraols and the like.

One useful type of polyester is provided for by reacting a dianhydride with a diol, optionally in the presence of a catalyst, the dianhydride and the diol being present in substantially stoichiometric amounts. The polyester formed can be further processed by either (A) partially or fully esterifying carboxyl groups on the polyester with a capping compound selected from monohydric alcohols and mixtures thereof optionally in the presence of a catalyst or (B) converting some or all carboxyl groups on the polyester to hydroxyl groups by reacting the carboxyl groups with a hydroxyl-forming compound selected from aromatic oxide, aliphatic oxide, alkylene carbonate and mixtures thereof optionally in the presence of a catalyst. In some instances, it may be beneficial to conduct the polymerization in a media which includes a solvent in which the polyester is insoluble.

The aforementioned polyesters can be also be made in a variety of other methods, such as (1): (i) reacting a dianhydride with a diol, optionally in the presence of a catalyst, the dianhydride and the diol being present in substantially stoichiometric amounts; (ii) separating the polyester from the media of step (i); and (iii) partially or fully esterifying carboxyl groups on the polyester of step (ii) with a capping compound selected from monohydric alcohols and mixtures thereof optionally in the presence of a catalyst; (2): (i) reacting a dianhydride with a diol, optionally in the presence of a catalyst, the dianhydride and the diol being present in substantially stoichiometric amounts; (ii) separating the polyester from the media of step (i); and (iii) converting some or all carboxyl groups on the polyester of step (ii) to hydroxyl groups by reacting the carboxyl groups with a hydroxyl-forming compound selected from aromatic oxide, aliphatic oxide, alkylene carbonate and mixtures thereof optionally in the presence of a catalyst; (3): (i) reacting a dianhydride with a diol, optionally in the presence of a catalyst, the dianhydride and the diol being present in substantially stoichiometric amounts; and (ii) partially or fully esterifying carboxyl groups on the polyester of step (i) with a capping compound selected from monohydric alcohols and mixtures thereof optionally in the presence of a catalyst; (4): (i) reacting a dianhydride with a diol, optionally in the presence of a catalyst, the dianhydride and the diol being present in substantially stoichiometric amounts; and (ii) converting some or all carboxyl groups on the polyester of step (i) to hydroxyl groups by reacting the carboxyl groups with a hydroxyl-forming compound selected from aromatic oxide, aliphatic oxide, alkylene carbonate and mixtures thereof optionally in the presence of a catalyst; and (5): (i) mixing together a dianhydride, a diol, and a hydroxyl-forming compound selected from aromatic oxide, aliphatic oxide, alkylene carbonate, and mixtures thereof under reaction conditions to react the dianhydride with the diol, the dianhydride and the diol being present in substantially stoichiometric amounts; (ii) reacting the mixture of (i) under conditions to react carboxyl groups on the polyester with the hydroxyl-forming compound to convert carboxyl groups to hydroxyl groups; and (iii) separating the polyester from step (ii). Optionally, a catalyst can be added to the mixture prior to step (ii).

In some instances, it may be beneficial to conduct the polymerization forming the polyester in a media which includes a solvent in which the polyester is insoluble.

In the above processes, the formed polyester can be then separated from the reaction media and further used in formulating various products.

Examples of the capping compound include methanol, ethanol, propanol, isopropanol, 1-butanol, isobutanol, 2-methyl-2-butanol, 2-methyl-1-butanol, 3-methyl-1-butanol, tertiary butanol, cyclopentanol, cyclohexanol, 1-hexanol, 1-heptanol, 2-heptanol, 3-heptanol, 1-n-octanol, 2-n-octanol and the like. Examples of the hydroxyl-forming compound include styrene oxide, propylene oxide, ethylene carbonate and the like.

For the above processes, the dianhydride can have the formula

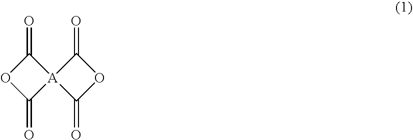

where A is a tetravalent radical selected from the group consisting of unsubstituted or substituted aliphatic, unsubstituted or substituted aromatic, unsubstituted or substituted cycloaliphatic, unsubstituted or substituted heterocyclic groups and combinations thereof. Tetravalent radical A can be selected from

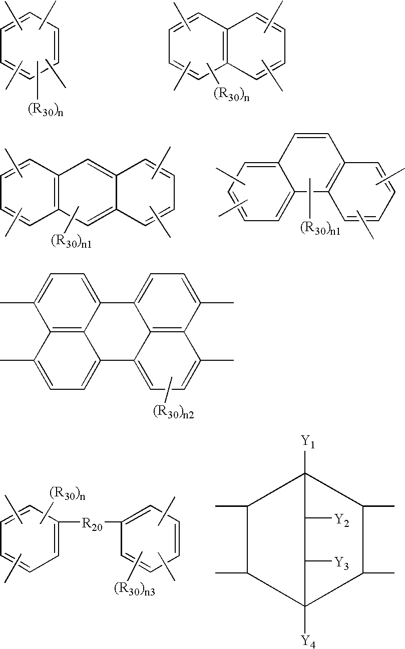

where R₃₀ is identical or different and is selected from hydrogen, unsubstituted or substituted hydrocarbyl group, or halogen; Y₁, Y₂, Y₃, and Y₄ are each independently selected from hydrogen and unsubstituted or substituted hydrocarbyl group; n=1 to 4, n1=1 to 6, n2=1 to 8, n3=1 to 4; and R₂₀ is selected from a direct bond, O, CO, S, COO, CH₂O, CHL, CL₂, CH₂COO, SO₂, CONH, CONL, NH, NL, OWO, OW, WO, WOW, and W, where L is unsubstituted or substituted hydrocarbyl group and W is unsubstituted or substituted hydrocarbylene group. Some examples of the compound of formula include

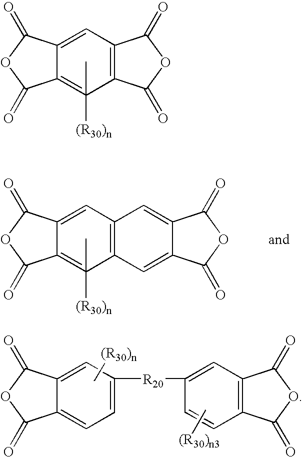

Examples of the dianhydride include pyromellitic dianhydride, 3,6-diphenylpyromellitic dianhydride, 3,6-bis(trifluoromethyl)pyromellitic dianhydride, 3,6-bis(methyl)pyromellitic dianhydride, 3,6-diiodopyromellitic dianhydride, 3,6-dibromopyromellitic dianhydride, 3,6-dichloropyromellitic dianhydride, 3,3′,4,4′benzophenonetetracarboxylic acid dianhydride, 2,3,3′,4′-benzophenonetetracarboxylic acid dianhydride, 2,2′,3,3′-benzophenone tetracarboxylic acid dianhydride, 3,3′,4,4′-biphenyltetracarboxylic acid dianhydride, 2,3,3′4′-biphenyltetracarboxylic acid dianhydride, 2,2′,3,3′-biphenyltetracarboxylic acid dianhydride, 2,2′,6,6′-biphenyltetracarboxylic acid dianhydride, bis(2,3-dicarboxyphenyl)methane dianhydride, bis(2,5,6-trifluoro-3,4-dicarboxyphenyl)methane dianhydride, 2,2-bis(3,4-dicarboxyphenyl)propane dianhydride, 2,2-bis(3,4-dicarboxyphenyl)-1,1,1,3,3,3-hexafluoropropane dianhydride, bis(3,4-dicarboxyphenyl)ether dianhydride (4,4′-oxydiphthalic dianhydride), bis(3,4-dicarboxyphenyl)sulfone dianhydride (3,3′,4,4′-diphenylsulfonetetracarboxylic dianhydride), 4,4′-[4,4′-isopropylidene-di(p-phenyleneoxy)]bis(phthalic anhydride), N,N-(3,4-dicarboxyphenyl)-N-methylamine dianhydride, bis(3,4-dicarboxyphenyl)diethylsilane dianhydride; 2,3,6,7-naphthalene tetracarboxylic acid dianhydride, 1,2,5,6-naphthalene-tetracarboxylic acid dianhydride, 1,4,5,8-naphthalenetetracarboxylic acid dianhydride, 2,6-dichloronaphthalene-1,4,5,8-tetracarboxylic acid dianhydride, thiophene-2,3,4,5-tetracarboxylic acid dianhydride, pyrazine-2,3,5,6-tetracarboxylic acid dianhydride, pyridine-2,3,5,6-tetracarboxylic acid dianhydride, 2,3,9,10-perylene tetracarboxylic acid dianhydride, 4,4′-(1,4-phenylene) bis(phthalic acid) dianhydride, 4,4′-(1,3-phenylene) bis(phthalic acid) dianhydride, 4,4′-oxydi(1,4-phenylene)bis(phthalic acid)dianhydride, 4,4′-methylenedi(1,4-phenylene)bis(phthalic acid)dianhydride, hydroquinonediether dianhydride, 4,4′-biphenoxy dianhydride, and bicyclo[2.2.2]oct-7-ene-2,3,5,6-tetracarboxylic dianhydride.

For the above processes, the diol can have the formula

HO—B—OH (2)

where B is an unsubstituted or substituted hydrocarbylene group. Examples of B include unsubstituted or substituted linear or branched alkylene optionally containing one or more oxygen or sulfur atoms, unsubstituted or substituted arylene, and unsubstituted or substituted aralkylene. Additional examples include methylene, ethylene, propylene, butylene, 1-phenyl-1,2-ethylene, 2-bromo-2-nitro-1,3-propylene, 2-bromo-2-methyl-1,3-propylene, —CH₂OCH₂—, —CH₂CH₂OCH₂CH₂—, —CH₂CH₂SCH₂CH₂—, or —CH₂CH₂SCH₂CH₂SCH₂CH₂—.

For the processes of the present invention, the dianhydride can be a mixture of one or more dianhydrides. Additionally, the diol can be a mixture of one or more diols.

As used herein, “substantially stoichiometric amount” refers to molar ratios of dianhydride/diol of about 1, and generally between about 0.90 to about 1.20. Typically, a slight excess of either dianhydride or diol can be used in order to control molecular weight.

As used herein, the term “hydrocarbyl group” is used in its ordinary sense, which is well-known to those skilled in the art, as a univalent group formed by removing one hydrogen atom from a moiety having a predominantly hydrocarbon character. Examples of hydrocarbyl groups, which can be unsubstituted or substituted, include:

(1) hydrocarbon groups, that are, aliphatic (e.g., alkyl, alkylenyl or alkenyl), alicyclic (e.g., cycloalkyl, cycloalkenyl), aromatic, aliphatic-, and alicyclic-substituted aromatic substituents, as well as cyclic substituents wherein the ring is completed through another portion of the molecule (e.g., two substituents together form an alicyclic radical); monocyclic or polycyclic alkylene, arylene, aralkylene. Examples of the monocyclic cycloalkylene group can have from 4 to 50 carbon atoms, and include such as, for example, cyclopentylene and cyclohexylene groups, and the polycyclic cycloalkylene group can have from 5 to 50 carbon atoms and include such as, for example, 7-oxabicyclo[2,2,1]heptylene, norbornylene, adamantylene, diamantylene, and triamantylene.

Examples of the arylene group include monocyclic and polycyclic groups such as, for example, phenylene, naphthylene, biphenyl-4,4′-diyl, biphenyl-3,3′-diyl, and biphenyl-3,4′-diyl groups.

Aryl refers to an unsaturated aromatic carbocyclic group of from 6 to 50 carbon atoms having a single ring or multiple condensed (fused) rings and include, but are not limited to, for example, phenyl, tolyl, dimethylphenyl, 2,4,6-trimethylphenyl, naphthyl, anthryl and 9,10-dimethoxyanthryl groups.

Aralkyl refers to an alkyl group containing an aryl group. It is a hydrocarbon group having both aromatic and aliphatic structures, that is, a hydrocarbon group in which an alkyl hydrogen atom is substituted by an aryl group, for example, tolyl, benzyl, phenethyl and naphthylmethyl groups.

(2) hydrocarbon groups that contain atoms other than carbon and hydrogen but are predominantly hydrocarbon in nature, where examples of other atoms are sulfur, oxygen or nitrogen, which may be present alone (such as thio or ether) or as functional linkages such as ester, carboxy, carbonyl, etc.;

(3) substituted hydrocarbon groups, that is, substituents containing non-hydrocarbon groups which, in the context of this invention, do not alter the predominantly hydrocarbon substituent (e.g., halogen, hydroxy, alkoxy, mercapto, alkylmercapto, nitro, nitroso, and sulfoxy);

(4) hetero substituents, that is, substituents which, while having a predominantly hydrocarbon character, in the context of this invention, contain other than carbon in a ring or chain otherwise composed of carbon atoms. Heteroatoms include sulfur, oxygen, nitrogen, and encompass substituents as pyridyl, furyl, thienyl and imidazolyl. In general, no more than two, preferably no more than one, non-hydrocarbon substituent will be present for every ten carbon atoms in the hydrocarbyl group; typically, there will be no non-hydrocarbon substituents in the hydrocarbyl group.

Examples of hydrocarbyl groups are substituted or unsubstituted linear or branched aliphatic (C₁₋₅₀) alkyl group, substituted or unsubstituted linear or branched aliphatic (C₁₋₅₀) alkylene group, substituted or unsubstituted linear or branched thio-alkylene aliphatic (C₁₋₅₀) group, substituted or unsubstituted cycloalkylene, substituted or unsubstituted benzyl, alkoxy alkylene, alkoxyaryl, substituted aryl, hetero cycloalkylene, heteroaryl, oxocyclohexyl, cyclic lactone, benzyl, substituted benzyl, hydroxy alkyl, hydroxyalkoxyl, alkoxy alkyl, alkoxyaryl, alkylaryl, alkenyl, substituted aryl, hetero cycloalkyl, heteroaryl, nitroalkyl, haloalkyl, alkylimide, alkyl amide, or mixtures thereof.

When Z is hydrocarbyl group, examples include alkyl, cycloalkyl, substituted cycloalkyl, oxocyclohexyl, cyclic lactone, benzyl, substituted benzyl, hydroxy alkyl, hydroxyalkoxyl, alkoxy alkyl, alkoxyaryl, alkylaryl, alkenyl, substituted aryl, hetero cycloalkyl, heteroaryl, nitro, halogen, haloalkyl, ammonium, alkyl ammonium, —(CH₂)₂OH, —O(CH₂)₂O(CH₂)OH, —(OCH₂CH₂)ₖOH (where k=1-10), or mixtures thereof.

As used herein, hydrocarbylene group is a divalent group formed by removing two hydrogen atoms from a moiety having a predominantly hydrocarbon character, the free valences of which are not engaged in a double bond. For example, hydrocarbylene groups include, but are not limited to, alkylene, thio-alkylene, cycloalkylene, arylene, examples of W set forth below and the like.

Examples of W are, without limitations, substituted or unsubstituted aliphatic (C₁-C₅₀) alkylene, substituted or unsubstituted aliphatic (C₁-C₅₀) thio-alkylene, (C₁-C₅₀) cycloalkylene, substituted (C₁-C₅₀) cycloalkylene, hydroxy alkylene, alkoxy alkylene, alkoxyarylene, alkylarylene, (C₁-C₅₀) alkenylene, biphenylene, phenylene, unsubstituted or substituted arylene, hetero cycloalkylene, heteroarylene, halo alkylene, or mixtures thereof. Examples of L are, without limitations, (C₁-C₅₀) alkyl, substituted (C₁-C₅₀) alkyl, cycloalkyl, substituted cycloalkyl, oxocyclohexyl, cyclic lactone, benzyl, substituted benzyl, hydroxy alkyl, hydroxyalkoxyl, alkoxy alkyl, alkoxyaryl, alkylaryl, alkenyl, substituted aryl, hetero cycloalkyl, heteroaryl, or mixtures thereof.

In the above definitions and throughout the present application, aliphatic refers to a predominantly hydrocarbon chain which is nonaromatic. Substituted or unsubstituted alkylene or thioalkylene (C₁-C₅₀) group means an alkylene or an thioalkylene group which is predominantly a hydrocarbon chain that may be linear or branched containing up to 50 carbon atoms, and where the substituents are those which do not typically change the hydrocarbon nature of the chain and may be all organic compounds known to those of ordinary skill in the art, such as ether, ester, hydroxyl, alkynol, cyano, nitro, acyl, halogen, phenyl and substituted phenyl. Alkyl refers to a hydrocarbon chain containing up to 50 carbon atoms, and may be methyl, ethyl, propyl, isopropyl, butyl, etc. A thioalkylene group contains one or more sulfur atoms in the chain. An oxoalkylene group contains one or more oxygen atoms in the chain. Examples of aliphatic substituted or unsubstituted alkylene (C₁-C₅₀) group which may be linear or branched, are without limitation, methylene, ethylene, propylene, isopropylene, butylenes, isobutylene, pentylene, hexylene, heptylene, octylene, methylhexylene, ethyloctylene, phenylalkylene, nitroalkylene, bromonitroalkylene and substituted phenylalkylene. An example of aliphatic substituted or unsubstituted thio-alkylene (C₁-C₅₀) group is without limitation, 3,6-dithio-1,8-octylene (also known as 1,2-bis(ethylthio)ethylene having the formula —CH₂CH₂SCH₂CH₂SCH₂CH₂— from 3,6-dithiaoctane-1,8-diol, also known at 2,2′-(ethylenethio)diethanol). The cycloalkyl groups may be mono or polycyclic, examples of which are cyclopentyl, cyclohexyl, cycloheptyl, adamantly, as well as those described above, and may be unsubstituted or substituted as described above. Aryl refers to substituted or unsubstituted aromatic groups such as phenyl or naphthyl or anthracyl. The aryl group may be part of the polymer backbone or linked to the backbone. Halogen refers to fluorine, chlorine and bromine.

Examples of B include hydrocarbylene groups as described above, for example, alkylene, thio-alkylene, oxoalkylene, aromatic or mixtures thereof, phenyl and naphthyl and substituted variations thereof. Examples include methylene, ethylene, propylene, butylene, —CH₂OCH₂—, —CH₂CH₂OCH₂CH₂—, —CH₂CH₂SCH₂CH₂—, —CH₂CH₂SCH₂CH₂SCH₂CH₂—, phenylethylene, alkylnitroalkylene, bromonitroalkylene, and the like.

Other examples include those where R₂₀ is CO or SO₂, and B is alkylene, for example, methylene, ethylene, propylene, —CH₂OCH₂—, —CH₂CH₂OCH₂CH₂—, —CH₂CH₂SCH₂CH₂—, —CH₂CH₂SCH₂CH₂SCH₂CH₂—, phenylethylene, alkylnitoalkylene, bromonitroalkylene, phenyl or naphthyl.

Examples of the diols used to synthesize the polymer of the present invention which are represented by the compound of formula (2) are, for example and include, ethylene glycol, diethylene glycol, propylene glycol, 1-phenyl-1,2-ethanediol, 2-bromo-2-nitro-1,3-propanediol, 2-methyl-2-nitro-1,3-propanediol, diethylbis(hydroxymethyl)malonate, 1,6-hexanediol, and 3,6-dithio-1,8-octanediol. Examples of aromatic diols are 2,6-bis(hydroxymethyl)-p-cresol and 2,2′-(1,2-phenylenedioxy)-diethanol, 1,4-benzenedimethanol.

The diols are condensed with dianhydride compounds of formula (1) of the present invention, examples of which include aromatic dianhydrides, examples of which include pyromellitic dianhydride, 3,6-diphenylpyromellitic dianhydride, 3,6-bis(trifluoromethyl)pyromellitic dianhydride, 3,6-bis(methyl)pyromellitic dianhydride, 3,6-diiodopyromellitic dianhydride, 3,6-dibromopyromellitic dianhydride, 3,6-dichloropyromellitic dianhydride, 3,3′,4,4′-benzophenonetetracarboxylic acid dianhydride, 2,3,3′,4′-benzophenonetetracarboxylic acid dianhydride, 2,2′,3,3′-benzophenone tetracarboxylic acid dianhydride, 3,3′,4,4′-biphenyltetracarboxylic acid dianhydride, 2,3,3′4′-biphenyltetracarboxylic acid dianhydride, 2,2′,3,3′-biphenyltetracarboxylic acid dianhydride, 2,2′,6,6′-biphenyltetracarboxylic acid dianhydride, bis(2,3-dicarboxyphenyl)methane dianhydride, bis(2,5,6-trifluoro-3,4-dicarboxyphenyl)methane dianhydride, 2,2-bis(3,4-dicarboxyphenyl)propane dianhydride, 2,2-bis(3,4-dicarboxyphenyl)-1,1,1,3,3,3-hexafluoropropane dianhydride, bis(3,4-dicarboxyphenyl)ether dianhydride (4,4′-oxydiphthalic dianhydride), bis(3,4-dicarboxyphenyl)sulfone dianhydride (3,3′,4,4′-diphenylsulfonetetracarboxylic dianhydride), 4,4′-[4,4′-isopropylidene-di(p-phenyleneoxy)]bis(phthalic anhydride), N,N-(3,4-dicarboxyphenyl)-N-methylamine dianhydride, bis(3,4-dicarboxyphenyl)diethylsilane dianhydride; 2,3,6,7-naphthalene tetracarboxylic acid dianhydride, 1,2,5,6-naphthalene-tetracarboxylic acid dianhydride, 1,4,5,8-naphthalenetetracarboxylic acid dianhydride, 2,6-dichloronaphthalene-1,4,5,8-tetracarboxylic acid dianhydride, thiophene-2,3,4,5-tetracarboxylic acid dianhydride, pyrazine-2,3,5,6-tetracarboxylic acid dianhydride, pyridine-2,3,5,6-tetracarboxylic acid dianhydride, 2,3,9,10-perylene tetracarboxylic acid dianhydride, 4,4′-(1,4-phenylene) bis(phthalic acid) dianhydride, 4,4′-(1,3-phenylene) bis(phthalic acid) dianhydride, 4,4′-oxydi(1,4-phenylene)bis(phthalic acid)dianhydride, 4,4′-methylenedi(1,4-phenylene)bis(phthalic acid)dianhydride, hydroquinonediether dianhydride, 4,4′-biphenoxy dianhydride, and bicyclo[2.2.2]oct-7-ene-2,3,5,6-tetracarboxylic dianhydride.

Typically a polyester is first prepared by the reaction of a dianhydride and a diol in a media which includes a solvent in which the polyester is insoluble. The polyester may be further modified by (A) partially or fully esterifying carboxyl groups on the polyester with a capping compound selected from monohydric alcohols and mixtures thereof in the presence of a catalyst or (B) converting some or all carboxyl groups on the polyester to hydroxyl groups by reacting the carboxyl groups with a hydroxyl-forming compound selected from aromatic oxide, aliphatic oxide, alkylene carbonate and mixtures thereof optionally in the presence of a catalyst.

Examples of monohydric alcohols include linear or branched C₁-C₁₀ alkanols such as methanol, ethanol, propanol, pentanol, isopropanol, 1-butanol, isobutanol, 2-methyl-2-butanol, 2-methyl-1-butanol, 3-methyl-1-butanol, tertiary butanol, benzyl alcohol, cyclopentanol, cyclohexanol, 1-hexanol, 1-heptanol, 2-heptanol, 3-heptanol, 1-n-octanol, 2-n-octanol and the like.

The hydroxyl-forming compound is selected from aromatic oxide, aliphatic oxide, alkylene carbonate and mixtures thereof.

Examples of aromatic oxides include: styrene oxide, 1,2-epoxy-phenoxypropane, glycidyl-2-methylphenyl ether, (2,3-epoxypropyl)benzene, 1-phenylpropylene oxide, stilbene oxide, 2- (or 3- or 4-)halo(chloro, fluoro, bromo, iodo) stilbene oxide, benzyl glycidyl ether, C₁₋₁₀ straight or branched chain alkyl(e.g., methyl, ethyl, propyl, butyl, sec-butyl, tert-butyl, pentyl, hexyl, heptyl, and the like etc)phenyl glycidyl ether, 4- halo(chloro, fluoro, bromo, iodo)phenyl glycidyl ether, glycidyl 4-C₁₋₁₀ straight or branched chain alkoxy(e.g., methoxy, ethoxy, propoxy, butoxy, hexyloxy, heptyloxy, and the like etc)phenyl ether, 2,6-dihalo(chloro, fluoro, bromo, iodo)benzylmethyl ether, 3,4-dibenzyloxybenzyl halide (chloride, fluoride, bromide, iodide), 2-(or 4-)methoxybiphenyl, 3,3′-(or 4,4′-)diC₁₋₁₀ straight or branched chain alkoxy(e.g., methoxy, ethoxy, propoxy, butoxy, hexyloxy, heptyloxy, and the like etc)biphenyl, 4,4′-dimethoxyoctafluorobiphenyl, 1-(or 2-)C₁₋₁₀ straight or branched chain alkoxy(e.g., methoxy, ethoxy, propoxy, butoxy, hexyloxy, heptyloxy, and the like etc)naphthalene, 2-halo(chloro, fluoro, bromo, iodo)-6-methoxynaphthalene, 2,6-diC₁₋₁₀ straight or branched chain alkoxy(e.g., methoxy, ethoxy, propoxy, butoxy, hexyloxy, heptyloxy, and the like etc)naphthalene, 2,7-diC₁₋₁₀ straight or branched chain alkoxy(e.g., methoxy, ethoxy, propoxy, butoxy, hexyloxy, heptyloxy, and the like etc)naphthalene, 1,2,3,4,5,6-hexahalo(chloro, fluoro, bromo, iodo)-7-C₁₋₁₀ straight or branched chain alkoxy(e.g., methoxy, ethoxy, propoxy, butoxy, hexyloxy, heptyloxy, and the like etc)naphthalene, 9,10-bis(4-C₁₋₁₀ straight or branched chain alkoxy(e.g., methoxy, ethoxy, propoxy, butoxy, hexyloxy, heptyloxy, and the like etc)phenyl)-anthracene, 2-C₁₋₁₀ straight or branched chain alkyl(e.g., methyl, ethyl, propyl, butyl, sec-butyl, tert-butyl, pentyl, hexyl, heptyl, and the like etc)-9,10-diC₁₋₁₀ straight or branched chain alkoxy(e.g., methoxy, ethoxy, propoxy, butoxy, hexyloxy, heptyloxy, and the like etc)anthracene, 9,10-bis(4-C₁₋₁₀ straight or branched chain alkoxy(e.g., methoxy, ethoxy, propoxy, butoxy, hexyloxy, heptyloxy, and the like etc)phenyl)-2-halo(chloro, fluoro, bromo, iodo)-anthracene, 2,3,6,7,10,11-hexamethoxytriphenylene, glycidyl-3-(pentadecadienyl)phenyl ether, 4-t-butylphenylglycidyl ether, triphenylolmethane triglycidyl ether, [(4-(1-heptyl-8-[3-(oxiranylmethoxy)phenyl]-octyl)phenoxy)methyl]oxirane, tetraphenylolethane tetraglycidyl ether, hydroxyphenol diglycidyl ether, etc.

Examples of aliphatic oxides include ethylene oxide, propylene oxide, butylene oxides, including isobutylene oxide, 1,2-butylene oxide and 2,3-butylene oxide, pentylene oxide, cyclohexene oxide, decyl glycidyl ether, and dodecyl glycidyl ether.

Examples of alkylene carbonates include those compounds having the formula

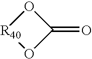

where R₄₀ is C₂-C₄ alkyl where the aliphatic ring carbons are unsubstituted or substituted with a group selected from C₁-C₁₀ alkyl, C₆-C₁₀ aryl, or C₆-C₁₅ aralkyl group. Examples of alkylene carbonates are ethylene carbonate, propylene carbonate, and butylene carbonates.

The reaction of the diol and dianhydride can take place in a media which includes a solvent, or mixture of solvents, in which the polyester with the desired molecular weight is insoluble or, in some instances, in the absence of solvent, for example, in the process where the dianhydride, diol, and hydroxyl-forming compound are mixed together, the hydroxyl-forming compound can function as a solvent, whether as in liquid form or, for example, when solid, for example, ethylene carbonate, by heating to its melting temperature, the reactants are in a liquid. Examples of solvents that are useful include dioxane, acetonitrile, mixture of tetrahydrofuran (THF)/acetonitrile, and mixture of THF/dioxane. It is useful to use a media where the dianhydride and diol are soluble and the polyester is not so that as the reaction progresses, the formed polyester will precipitate out of solution.

The temperature at which the reactions occur generally ranges from about room temperature to about 170° C. The reaction time can vary from about 4 to about 48 hours.

Where the dianhydride, diol, and hydroxyl-forming compound selected from aromatic oxide, aliphatic oxide, alkylene carbonate, and mixtures thereof are mixed together under reaction conditions to react the dianhydride with the diol, the dianhydride and the diol being present in substantially stoichiometric amounts, the mixing optionally occurring in a media in which the polyester is insoluble, the reaction conditions are typically a reaction time of from about 3 to about 24 hours at a temperature ranging from about 50 to about 140° C. Optionally, to continue the reaction with the formed polyester and the hydroxyl-forming compound, a catalyst can be added to the mixture. The temperature of the mixture can be the same as that used to react the dianhydride with the diol or a different range of, for example, from about 60 to about 170° C. The reaction time can range from 4 to 24 hours.

Processing the polyester with a hydroxyl-forming compound can result in either generally linear polyesters or partially crosslinked polyesters, depending upon the temperature at which the hydroxyl-forming compound is reacted with the polyester. Generally, if the reaction temperature is about less than or equal to 80° C., the resulting polyester is generally linear. Generally, if the reaction temperature is about greater than or equal to 80° C., the resulting polyester generally has some partial crosslinking occurring.

The reaction of the hydroxyl-forming compound and polyester is normally carried out at atmospheric pressure under inert gas atmosphere. However, if the hydroxyl-forming compound has a boiling point lower than the reaction temperature and no additional solvent is used, increased pressure can be used.

Typical weight average molecular weights of the polyesters prepared by the present process range from about 1,500 to about 300,000, further from about 1500 to about 180,000, further from about 4,000 to about 60,000 and more further from about 10,000 to about 30,000. When the weight average molecular weight is below 1,500, then good film forming properties are not obtained for the antireflective coating and when the weight average molecular weight is too high, then properties such as solubility, storage stability and the like may be compromised.

Recovery of the polyester from the reaction media can be done by conventional methods. For example, the reaction mixture containing the polyester as a precipitate can be filtered to remove the solid polymer. The solid monomer can then be rinsed with water or ether. The polyester also can be isolated by pouring the reaction mixture into a non-solvent for the polyester and collecting the precipitated product. Additionally, the polyester can be isolated by removal of the solvent by vacuum distillation.

While the reaction between the dianhydride and diol typically does not need the presence of a catalyst, catalysts which are well known to those skilled in the art can be added to increase the reaction rate. A catalyst can optionally be used when reacting the polyester (from the reaction between dianhydride and diol)) with either the capping compound or the hydroxyl-forming compound. Examples of suitable catalysts include onium salts, for example, phosphonium, ammonium, or sulfonium salts. Examples include benzyltributylammonium chloride, benzyltriethylammonium chloride, and benzyltrimethylammonium chloride. When reacting the polyester with the capping compound, inorganic acids such as sulfuric acid can also be used.

Examples of these polyesters include those which contain at least one unit selected from formulas (3), (4) and (5)

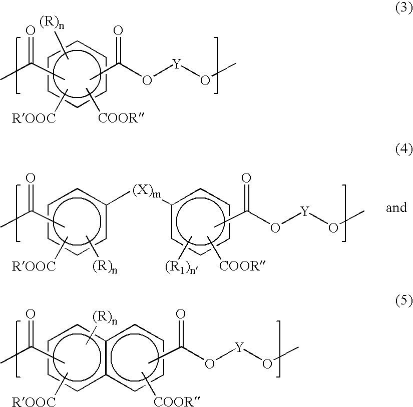

where Y is a hydrocarbyl linking group of 1 to about 10 carbon atoms, R, R₁, R′ and R″ are independently hydrogen, hydrocarbyl group of 1 to about 10 carbon atoms, halogen, —O(CO)Z, —C(CF₃)₂Z, —C(CF₃)₂(CO)OZ, —SO₂CF₃, —(CO)OZ, —SO₃Z, —COZ, —OZ, —NZ₂, —SZ, —SO₂Z, —NHCOZ, —NZCOZ or —SO₂NZ₂, where Z is H or a hydrocarbyl group of 1 to about 10 carbon atoms, n=1-4, n′=1-4, X is O, CO, S, COO, CH₂O, CH₂COO, SO₂, NH, NL, OWO, OW, WO, WOW, W, and where L is unsubstituted or substituted hydrocarbyl group and W is unsubstituted or substituted hydrocarbylene group, and m=0-3.

Further examples include formulas (3) to (5) where R, R₁, R′ and R″ are independently Z, —O(CO)OZ, —C(CF₃)₂Z, —C(CF₃)₂(CO)Z, —SO₂CF₃, —(CO)OZ, —SO₃Z, —COZ, —OZ, —NZ₂, —SZ, —SO₂Z, CN, NO₂, —NHCOZ, —NZCOZ or —SO₂NZ₂, or mixtures thereof, where Z is independently H, or a hydrocarbyl group. Further where Z is H, halogen or alkyl, cycloalkyl, substituted cycloalkyl, oxocyclohexyl, cyclic lactone, benzyl, substituted benzyl, hydroxy alkyl, hydroxyalkoxyl, alkoxy alkyl, alkoxyaryl, alkylaryl, alkenyl, substituted aryl, hetero cycloalkyl, heteroaryl, nitro, halo, haloalkyl, ammonium, alkyl ammonium, or mixtures thereof. Examples of Z are given here but are not limited to these: —(CH₂)₂OH, —O(CH₂)₂O(CH₂)OH, —(OCH₂CH₂)ₖOH (where k=0-10).

Further embodiments include polyesters represented by formulas (6) to (9):

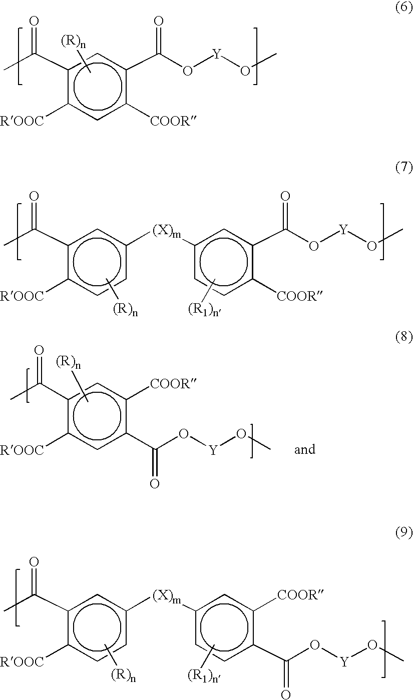

where Y is a hydrocarbyl linking group of 1 to about 10 carbon atoms, R, R₁, R′ and R″ are independently hydrogen, hydrocarbyl group of 1 to about 10 carbon atoms, halogen, —O(CO)Z, —C(CF₃)₂Z, —C(CF₃)₂(CO)OZ, —SO₂CF₃, —(CO)OZ, —SO₃Z, —COZ, —OZ,-NZ₂, —SZ, —SO₂Z, —NHCOZ, —NZCOZ or —SO₂NZ₂, where Z is H or a hydrocarbyl group of 1 to about 10 carbon atoms, n=1-4, n′=1-4, X is O, CO, S, COO, CH₂O, CH₂COO, SO₂, NH, NL, OWO, OW, WO, WOW, W, and where L is unsubstituted or substituted hydrocarbyl group and W is unsubstituted or substituted hydrocarbylene group, and m=0-3.

In certain embodiments of the polyester, Y is alkylene, thio-alkylene, aromatic or mixtures thereof; additional embodiments include those where Y is methylene, ethylene, propylene, butylene, —CH₂OCH₂—, —CH₂CH₂OCH₂CH₂—, —CH₂CH₂SCH₂CH₂—, —CH₂CH₂SCH₂CH₂SCH₂CH₂—, phenylethylene, dithiaoctylene, alkylnitroalkylene, bromonitroalkylene, phenyl, naphthyl, and derivatives thereof.

In another embodiments, X is CO or SO₂, and Y is alkylene, further where Y is methylene, ethylene, propylene, —CH₂OCH₂—, —CH₂CH₂OCH₂CH₂—, —CH₂CH₂SCH₂CH₂—, —CH₂CH₂SCH₂CH₂SCH₂CH₂—, phenylethylene, alkylnitoalkylene, bromonitroalkylene, phenyl or naphthyl.

Some of the monomers which may be used to synthesize these polymers and which can represent the Y component include, for example, diols, glycols and oxides, examples of which are, ethylene glycol, diethylene glycol, propylene glycol, propylene oxide, ethylene oxide, butylenes oxide, 1-phenyl-1,2-ethanediol, 2-bromo-2-nitro-1,3-propane diol, 2-methyl-2-nitro-1,3-propanediol, diethylbis(hydroxymethyl)malonate, and 3,6-dithia-1,8-octanediol. Examples of aromatic diols are 2,6-bis(hydroxymethyl)-p-cresol and 2,2′-(1,2-phenylenedioxy)-diethanol, 1,4-benzenedimethanol.

In certain instances it is important to control the etch resistance and absorptivity of the antireflective coating. In order to provide the desired etch rate of the antireflective coating, especially for imaging below 200 nm, the degree of aromaticity in the polymer may be varied. For high etch rates the Y component in the polymer backbone is preferably nonaromatic. It is generally known to those of ordinary skill in the art that aromatics decrease the etch rate. For low etch rates and/or high absorptivity, highly aromatic polymers are desirable, where the Y component may be highly aromatic. However, in some embodiments, particularly for imaging at wavelengths below 200 nm, optimum performance may be obtained by controlling the etch rate and the absorptivity by using an aliphatic monomer for Y or an appropriate mixture of an aliphatic and an aromatic monomer. The aromatic functionality may also be incorporated at other functional points within the polymer.

Polymers of this type are further disclosed in U.S. patent application Ser. No. 10/301,462, filed Nov. 21, 2002, and Ser. No. 10/817,987 filed Apr. 5, 2004, the contents of both applications being hereby incorporated herein by reference.

The antireflective coating composition comprises at least a first resin and a second resin, based on, for example, polymers mentioned above and an organic solvent. Optionally an acid or/and an acid generator may be added to the composition. Additionally, a crosslinking agent may be added but is not completely essential to the performance of the antireflective coating if the antireflective coating composition is made up of all polyether based polymers. If there is used a polyester polymer, then crosslinkers are typically added. Generally, polymeric crosslinkers may be preferred to monomeric crosslinkers, if a more stable film is desired. These crosslinkers have reactive sites (e.g. hydroxy, carboxy, etc) which can bind with the polymer.

Crosslinking agents are those agents which are capable of forming a crosslinked structure under the action of an acid. Some examples of crosslinking agents include aminoplasts such as, for example, glycoluril-formaldehyde resins, melamine-formaldehyde resins, benzoguanamine-formaldehyde resins, and urea-formaldehyde resins. The use of methylated and/or butylated forms of these resins is are useful in obtaining long storage life (3-12 months) in catalyzed form. Highly methylated melamine-formaldehyde resins having degrees of polymerization less than two are useful. Monomeric, methylated glycoluril-formaldehyde resins are useful for preparing thermosetting polyester anti-reflective coatings which can be used in conjunction with acid-sensitive photoresists. One example is N,N,N,N-tetra(alkoxymethyl)glycoluril. Examples of N,N,N,N-tetra(alkoxymethyl)glycoluril, may include, e.g., N,N,N,N-tetra (methoxymethyl)glycoluril, N,N,N,N-tetra(ethoxymethyl)glycoluril, N,N,N,N-tetra(n-propoxymethyl) glycoluril, N,N,N,N-tetra(i-propoxymethyl)glycoluril, N,N,N,N-tetra(n-butoxymethyl) glycoluril and N,N,N,N-tetra(t-butoxymethyl)glycoluril. N,N,N,N-tetra (methoxymethyl)glycoluril is available under the trademark POWDERLINK from Cytec Industries (e.g., POWDERLINK 1174). Other examples include methylpropyltetramethoxymethyl glycoluril, and methylphenyltetramethoxymethyl glycoluril. Similar materials are also available under the NIKALAC tradename from Sanwa Chemical (Japan).

Other aminoplast crosslinking agents are commercially available from Cytec Industries under the trademark CYMEL and from Monsanto Chemical Co. under the trademark RESIMENE. Condensation products of other amines and amides can also be employed, for example, aldehyde condensates of triazines, diazines, diazoles, guanidines, guanimines and alkyl- and aryl-substituted derivatives of such compounds, including alkyl- and aryl-substituted melamines. Some examples of such compounds are N,N′-dimethyl urea, benzourea, dicyandiamide, formaguanamine, acetoguanamine, ammeline, 2-chloro-4,6-diamino-1,3,5-triazine, 6-methyl-2,4-diamino, 1,3,5-triazine, 3,5-diaminotriazole, triaminopyrimidine, 2-mercapto4,6-diamino-pyrimidine, 3,4,6-tris(ethylamino)-1,3,5-triazine, tris(alkoxycarbonylamino)triazine, N,N,N′,N′-tetramethoxymethylurea, methylolbenzoguanamine or alkyl ether compound thereof, such as tetramethylolbenzoguanamine, tetramethoxymethylbenzoguanamine and trimethoxymethylbenzoguanamine; 2,6-bis(hydroxymethyl)-4-methylphenol or alkyl ether compound thereof; 4-tert-butyl-2,6-bis(hydroxymethyl)phenol or alkyl ether compound thereof; 5-ethyl-1,3-bis(hydroxymethyl)perhydro-1,3,5-triazin-2-one (common name: N-ethyldimethyloltriazine) or alkyl ether compound thereof; N,N-dimethyloltrimethyleneurea or dialkyl ether compound thereof; 3,5-bis(hydroxymethyl)perhydro-1,3,5-oxadiazin-4-one (common name: dimethylolurone) or alkyl ether compound thereof; and tetramethylolglyoxazaldiurein or dialkyl ether compound thereof and the like.

Other possible crosslinking agents include: 2,6-bis(hydroxymethyl)-p-cresol and compounds, such as those found in Japanese Laid-Open Patent Application (Kokai) No. 1-293339 to Tosoh, methylolmelamines, such as hexamethylolmelamine, pentamethylolmelamine, and tetramethylolmelamine as well as etherified amino resins, for example alkoxylated melamine resins (for example, hexamethoxymethylmelamine, pentamethoxymethylmelamine, hexaethoxymethylmelamine, hexabutoxymethylmelamine and tetramethoxymethylmelamine) or methylated/butylated glycolurils, for example as well as those found in Canadian Patent No. 1 204 547 to Ciba Specialty Chemicals. Other examples include, for example, N,N,N,N-tetrahydroxymethylglycoluril, 2,6-dihydroxymethylphenol, 2,2′,6,6′-tetrahydroxymethyl-bisphenol A, 1,4-bis[2-(2-hydroxypropyl)]benzene, and the like, etc. Other examples of crosslinking agents include those described in U.S. Pat. Nos. 4,581,321, 4,889,789, and DE-A 36 34 371, the contents of which are incorporated by reference. Various melamine and urea resins are commercially available under the Nikalacs (Sanwa Chemical Co.), Plastopal (BASF AG), or Maprenal (Clariant GmbH) tradenames.

The acid generator of the present invention, preferably a thermal acid generator is a compound which, when heated to temperatures greater than 90° C. and less than 250° C., generates an acid. The acid enables the polymer to be crosslinked. The antireflective film after heat treatment becomes insoluble in the solvents used for coating photoresists, and furthermore, is also insoluble in the alkaline developer used to image the photoresist. In most cases, the thermal acid generator is activated at about 90° C. and further at above about 120° C., and even more further at above about 150° C. The antireflective film is heated for a sufficient length of time to crosslink the coating. Examples of thermal acid generators are nitrobenzyl tosylates, such as 2-nitrobenzyl tosylate, 2,4-dinitrobenzyl tosylate, 2,6-dinitrobenzyl tosylate, 4-nitrobenzyl tosylate; benzenesulfonates such as 2-trifluoromethyl-6-nitrobenzyl 4-chlorobenzenesulfonate, 2-trifluoromethyl-6-nitrobenzyl 4-nitro benzenesulfonate; phenolic sulfonate esters such as phenyl, 4-methoxybenzenesulfonate; alkyl ammonium salts of organic acids, such as triethylammonium salt of 1 0-camphorsulfonic acid.

Thermal acid generators are preferred over free acids, although free acids may also be used, in the antireflective composition, since it is possible that over time the shelf stability of the antireflective solution will be affected by the presence of the acid, if the polymer were to crosslink in solution. Thermal acid generators are only activated when the antireflective film is heated on the substrate. Additionally, mixtures of thermal acids and free acids may be used. Although thermal acid generators are preferred for crosslinking the polymer efficiently, an antireflective coating composition comprising the polymer and optionally a crosslinking agent may also be used, where heating crosslinks the polymer. Examples of a free acid are, without limitation, strong acids, such as sulfonic acids. Sulfonic acids such as toluene sulfonic acid, triflic acid or mixtures of these are useful.

The composition may further contain a photoacid generator, examples of which without limitation, are onium salts, sulfonate compounds, nitrobenzyl esters, triazines, etc. The preferred photoacid generators are onium salts and sulfonate esters of hydoxyimides, specifically diphenyl iodonium salts, triphenyl sulfonium salts, dialkyl iodonium salts, triakylsulfonium salts, and mixtures thereof.

Typical solvents, used as mixtures or alone, that can be used for the present composition, without limitation, are propylene glycol monomethyl ether acetate (PGMEA), propylene gycol monomethyl ether (PGME), and ethyl lactate (EL), 2-heptanone, cyclopentanone, cyclohexanone, methyl-2-hydroxyisobutyrate, and gamma butyrolactone, as well as other solvents typically used in electronic materials. Solvents with a lower degree of toxicity, good coating and solubility properties are generally preferred.

The antireflective coating composition comprises the polymer, the acid generator and a suitable solvent or mixtures of solvents. Other components may be added to enhance the performance of the coating, e.g. monomeric dyes, polymeric dyes, monomeric or polymeric crosslinkers, lower alcohols, surface leveling agents, adhesion promoters, antifoaming agents, etc. Other secondary polymers, which can function as dyes and/or crosslinkers may be used, such as, novolaks, polyhydroxystyrene, polymethacrylate, polyarylates, poly(hydroxystyrene-methylmethacrylate), homopolymers and/or copolymers obtained by polymerization of at least one of the following monomers: styrene, hydroxystyrene, hydroxyethyl (methyl)acrylate, hydroxypropyl (methyl)acrylate, methyl (methyl)acrylate, ethyl (methyl)acrylate, (methyl)acrylic acid, polymers described in U.S. Pat. No. 6,465,148, U.S. Pat. No. 5,733,714, U.S. Pat. No. 6,737,492, U.S. Pat. No. 6,187,506 and U.S. Pat. No. 5,981,145. The optional secondary polymer may be up to 95 weight % of the total solids of the composition, in some instances, about 5 weight % to about 60 weight %; but ultimately, the amount of the secondary polymers added depends on the lithographic properties desired.

The amount of the polymer in the present composition can vary from about 100 weight % to about 50 weight %, further from about 85 weight % to about 70 weight % and more further from about 80 weight % to about 70 weight %, relative to the solid portion of the composition. The amount of optional crosslinker in the present composition can vary from 5 weight % to about 50 weight %, further from about 15 weight % to about 30 weight % relative to the solid portion of the composition. The amount of the optional acid or acid generator in the present composition can vary from about 0.1 weight % to about 5 weight %, further from about 0.5 weight % to about 3 weight % and more further from about 1 weight % to about 2 weight %, relative to the solid portion of the composition.

The optical characteristics of the antireflective coating are optimized for a variety of uses which depend upon the substrate to be coated, the illumination conditions, and the feature sizes. In most cases, either a customer will have a set of required optical characteristics (for example, index of refraction (n) and absorption parameter (k) for a specific application or approximate optical characteristics can be determined using simulation techniques (for example, Prolith, KLA-Tencor (San Jose, Calif.)) to find the index of refraction (n) and the absorption parameter (k) which minimize reflectivity. The measured index of refraction (n) and absorption parameter (k) of films formed from the antireflective coating composition using each polymer, when each polymer is formulated separately into the coating composition, typically fall within a range of, for the index of refraction (n) from about 1.3 to about 2.0, and for the absorption parameter (k) from about 0.1 to about 0.5, as measured using ellipsometry.

With the present invention, it has been found that by mixing two (and in some cases more) different polymers (for example, a polyester and a polyether, two different polyesters, or two different polyethers), the optical parameters index of refraction (n) and absorption parameter (k) can be tuned to meet the optical parameters of required by a customer or determined by simulation. Using different amounts of polymers, which when each is formulated into an antireflective coating compositions, films formed from the antireflective coating compositions have certain optical parameters(n)/(k), for example, ranging from about 1.50/0.27 to about 1.77/0.17 to about 1.74/0.17 to about 1/81/0.13 to about 1.90/0.34 to about 1.84/0.34, antireflective coating compositions containing two of these resins can have optical parameters (n)/(k) ranging from about 1.59/0.22 to about 1.83/0.21 to about 1.85/0.25 to about 1.75/017. The films formed by the formulated antireflective coating compositions can have (n)/(k) values which are within ±0.1/within ±0.02 of a customer's required optical characteristics or optical characteristics can be determined using simulation techniques.

Since the antireflective film is coated on top of the substrate and is further subjected to dry etching, it is envisioned that the film is of sufficiently low metal ion level and of sufficient purity that the properties of the semiconductor device are not adversely affected. Treatments such as passing a solution of the polymer, or even the fully formulated antireflective coating composition, through an ion exchange column, filtration, and extraction processes can be used to reduce the concentration of metal ions and to reduce particles.

The antireflective coating composition is coated on the substrate using techniques well known to those skilled in the art, such as dipping, spin coating or spraying. The film thickness of the antireflective coating ranges from about 20 nm to about 200 nm. The optimum film thickness is determined, as is well known in the art, to be where no standing waves are observed in the photoresist. The coating is further heated on a hot plate or convection oven for a sufficient length of time to remove any residual solvent and induce crosslinking, and thus insolubilizing the antireflective coating to prevent intermixing between the antireflective coating and the photoresist layer.

Photoresists can be any of the types used in the semiconductor industry, provided the photoactive compound in the photoresist and the antireflective coating absorb at the exposure wavelength used for the imaging process.

There are two types of photoresist compositions, negative-working and positive-working. When negative-working photoresist compositions are exposed image-wise to radiation, the areas of the resist composition exposed to the radiation become less soluble to a developer solution (e.g. a cross-linking reaction occurs) while the unexposed areas of the photoresist coating remain relatively soluble to such a solution. Thus, treatment of an exposed negative-working resist with a developer causes removal of the non-exposed areas of the photoresist coating and the creation of a negative image in the coating, thereby uncovering a desired portion of the underlying substrate surface on which the photoresist composition was deposited.

On the other hand, when positive-working photoresist compositions are exposed image-wise to radiation, those areas of the photoresist composition exposed to the radiation become more soluble to the developer solution (e.g. a rearrangement reaction occurs) while those areas not exposed remain relatively insoluble to the developer solution. Thus, treatment of an exposed positive-working photoresist with the developer causes removal of the exposed areas of the coating and the creation of a positive image in the photoresist coating. Again, a desired portion of the underlying surface is uncovered.

Positive working photoresist compositions are currently favored over negative working resists because the former generally have better resolution capabilities and pattern transfer characteristics. Photoresist resolution is defined as the smallest feature which the resist composition can transfer from the photomask to the substrate with a high degree of image edge acuity after exposure and development. In many manufacturing applications today, resist resolution on the order of less than one micron are necessary. In addition, it is almost always desirable that the developed photoresist wall profiles be near vertical relative to the substrate. Such demarcations between developed and undeveloped areas of the resist coating translate into accurate pattern transfer of the mask image onto the substrate. This becomes even more critical as the push toward miniaturization reduces the critical dimensions on the devices.

Any photoresists sensitive to ultraviolet radiation may be used. Photoresists based on novolac resins and diazonaphthoquinone diazide are suitable for radiation wavelengths between 450 nm and 300 nm. Such photoresists are described in U.S. Pat. No. 5,162,510 and U.S. Pat. No. 5,371,169. Photoresists sensitive at short wavelengths, between about 180 nm and about 300 nm can also be used in the present invention. These photoresists normally comprise polyhydroxystyrene or substituted polyhydroxystyrene derivatives, a photoactive compound, and optionally a solubility inhibitor. The following references exemplify the types of photoresists used and are incorporated herein by reference, U.S. Pat. No. 4,491,628, U.S. Pat. No. 5,069,997 and U.S. Pat. No. 5,350,660. Particularly preferred for 193 nm and 157 nm exposure are photoresists comprising non-aromatic polymers, a photoacid generator, optionally a solubility inhibitor, and solvent. Photoresists sensitive at 193 nm that are known in the prior art are described in the following references and incorporated herein, EP 794458, WO 97/33198 and U.S. Pat. No. 5,585,219, although any photoresist sensitive at 193 nm may be used on top of the antireflective composition of this invention. Fluorinated polymers are known for being transparent at 193 nm and 157 nm. Such polymers when used in a photoresist are disclosed in EP 789,278, WO 00/67072 and WO 00/17712. WO 00/67072 specifically discloses nonaromatic, alicyclic polymers with pendant fluorinated groups.

Thus, it is now possible to take an existing antireflective coating composition and, with the addition of another polymer resin, which when formed into a film has a certain index of refraction (n) and absorption parameter (k), can now cause the optical parameters of the antireflective coating compaotion to change in order to meet the optical parameters of the photoresist.

The process of the invention further comprises coating a substrate with the antireflective coating and heating on a hotplate or convection oven at a sufficiently high temperature for sufficient length of time to remove the coating solvent, and crosslink the polymers to a sufficient extent so that the coating is not soluble in the coating solution of the photoresist or in the aqueous alkaline developer. An edge bead remover may be applied to clean the edges of the substrate using processes well known in the art. The preferred range of temperature is from about 90° C. to about 250° C. If the temperature is below 90° C. then insufficient loss of solvent or insufficient amount of crosslinking takes place, and at temperatures above 250° C. the composition may become chemically unstable. A film of photoresist is then coated on top of the antireflective coating and baked to substantially remove the photoresist solvent. The photoresist is imagewise exposed and developed in an aqueous developer to remove the treated photoresist. The developer is preferably an aqueous alkaline solution comprising, for example, tetramethyl ammonium hydroxide. An optional heating step can be incorporated into the process prior to development and after exposure. The developer may additionally contain additives to enhance the imaging process, such as surfactants, polymers, etc.

The process of coating and imaging photoresists is well known to those skilled in the art and is optimized for the specific type of resist used. The patterned substrate can then be dry etched with an etching gas or mixture of gases, in a suitable etch chamber to remove the exposed portions of the antireflective film, with the remaining photoresist acting as an etch mask. Various gases are known in the art for etching organic antireflective coatings, such as O₂, Cl₂, F₂ and CF₄.

An intermediate layer may be placed between the antireflective coating and the photoresist to prevent intermixing, and is envisioned as lying within the scope of this invention. The intermediate layer is an inert polymer cast from a solvent, where examples of the polymer are polysulfones and polyimides.

Each of the documents referred to above are incorporated herein by reference in its entirety, for all purposes. The following specific examples will provide detailed illustrations of the methods of producing and utilizing compositions of the present invention. These examples are not intended, however, to limit or restrict the scope of the invention in any way and should not be construed as providing conditions, parameters or values which must be utilized exclusively in order to practice the present invention.

### POLYMER EXAMPLE 1

1.0 mole of pyromellitic dianhydride was suspended in 300 g of acetonitrile in a 1 L-flask with a condenser and a mechanical stirrer. Then equimolar ethylene glycol was added. Under nitrogen, the mixture was heated to a gentle reflux. The reaction was continued for 24 hours. After cooling the reaction mixture to room temperature, stirring was continued for a few hrs. The white precipitate formed during the reaction was collected by suction and washed thoroughly with acetonitrile. The solid was dried in a vacuum oven for 1 day. 300 g of propylene oxide and 300 g of acetonitrile were charged into a 2 L flask with a magnetic bar and a condenser. To this were added 52 g of the solid prepared from above and 2.5 g of benzyltriethylammonioum chloride. Under nitrogen, the reaction mixture was heated to a gentle reflux. The reaction was maintained for 20 hours. After cooling to room temperature, the reaction solution was poured slowly into a large amount of water while stirring. The polymer was collected by suction and washed thoroughly with water and finally dried in vacuum oven for 1 day. The overall yield was about 70%. The polymer obtained had a weight average molecular weight of about 7000 and a polydispersity of 2.1.

### POLYMER EXAMPLE 2

400 grams of tetramethoxymethyl glycoluril, 132 grams of neopentyl glycol, 51.4 grams of 3,4,5-trimethoxybenzyl alcohol and 1170 grams of PGMEA were charged into a 2000 mL flask with a thermometer, a cold water condenser and a mechanical stirrer. The reaction mixture was heated to 85° C. After a catalytic amount of para-toluenesulfonic acid monohydrate was added, the reaction was maintained at this temperature for 6 hours. The reaction solution was then cooled to room temperature and filtered. The polymer was precipitated in Di water and collected in a filter, washed thoroughly with water and dried in a vacuum oven (200 grams were obtained). The polymer obtained had a weight average molecular weight of about 8,000 g/mol and a polydispersity of 3.

### POLYMER EXAMPLE 3

1000 grams of tetramethoxymethyl glycoluril, 500 grams of neopentyl glycol and 3000 grams of PGMEA were charged into a 5000 mL flask with a thermometer, a cold water condenser and a mechanical stirrer. The reaction mixture was heated to 85° C. After catalytical amount of para-toluenesulfonic acid monohydrate was added, the reaction was maintained at this temperature for 8.0 hr. The reaction solution was then cooled to room temperature and filtered. The polymer was precipitated in Di water and collected on a filter, washed thoroughly with water and dried in a vacuum oven (400 grams obtained). The polymer obtained had a weight average molecular weight of about 8,000 g/mol and a polydispersity of 3.

### POLYMER EXAMPLE 4

600 grams of tetramethoxymethyl glycoluril, 96 grams of styrene glycol and 1200 grams of PGMEA were charged into a 2 L jacketed flask with a thermometer, mechanical stirrer and a cold water condenser and heated to 85° C. A catalytical amount of para-toluenesulfonic acid monohydrate was added, and the reaction was maintained at this temperature for 5 hrs. The reaction solution was then cooled to room temperature and filtered. The filtrate was slowly poured into distilled water to precipitate the polymer. The polymer was filtered, washed thoroughly with water and dried in a vacuum oven (250 grams of the polymer were obtained). The polymer obtained had a weight average molecular weight of about 17,345 g/mol and a polydispersity of 2.7.

### POLYMER EXAMPLE 5

300 grams of tetramethoxymethyl glycoluril, 118 grams of 4-methoxyphenol, 134 grams of styrene glycol and 1100 grams of PGMEA were charged into a 2000 mL flask with a thermometer, a cold water condenser and a mechanical stirrer. The reaction mixture was heated to 75° C. After a catalytic amount of para-toluenesulfonic acid monohydrate was added, the reaction was maintained at this temperature for 6 hours. The reaction solution was then cooled to room temperature and filtered. The polymer was precipitated in Di water and collected in a filter, washed thoroughly with water and dried in a vacuum oven (260 grams were obtained). The polymer obtained had a weight average molecular weight of about 4,400 g/mol and a polydispersity of 2.8.

### BARC FORMULATION EXAMPLE 1

An antireflective coating composition was prepared by dissolving 2.4 g of the polymer from Polymer Example 1, 0.72 g of tetrakis (methoxymethyl)glycoluril, 0.048 g of triethylammonium salt of 10-camphorsulfonic acid in 47.6 g ethyl lactate. The solution was filtered through 0.2 μm filter. An aliquot of the filtered solution was spun onto an 8″ silicon wafer at 2500 rpm and the wafer was then baked at 200° C. for 90 seconds to give a film thickness of 75 nm (as measured on a J.A. Woollam VUV-Vase Ellipsometer, ModelVU-302). Optical constants, n and k, measured on the Ellipsometer, were n (193 nm)=1.50, k (193 nm)=0.27.

### BARC FORMULATION EXAMPLE 2

An antireflective coating composition was prepared by dissolving 4 g of the polymer from Polymer Example 2, 0.08 g of triethylammonium salt of 10-camphorsulfonic acid in 100 g ethyl lactate. The solution was filtered through 0.2 μm filter. An aliquot of the filtered solution was spun onto an 8″ silicon wafer at 2500 rpm and the wafer was then baked at 200° C. for 90 seconds to give a film thickness of 70 nm (as measured on a J.A. Woollam VUV-Vase Ellipsometer, ModelVU-302). Optical constants, n and k, measured on the Ellipsometer, were n (193 nm)=1.77, k (193 nm)=0.17.

### BARC FORMULATION EXAMPLE 3

An antireflective coating composition was prepared by dissolving 2 g of the polymer from Polymer Example 1, 2 g of the polymer from Polymer Example 2, 0.08 g of triethylammonium salt of 1 0-camphorsulfonic acid in 100 g ethyl lactate. The solution was filtered through 0.2 μm filter. An aliquot of the filtered solution was spun onto an 8″ silicon wafer at 2500 rpm and the wafer was then baked at 200° C. for 90 seconds to give a film thickness of 70 nm (as measured on a J.A. Woollam VUV-Vase Ellipsometer, ModelVU-302). Optical constants, n and k, measured on the Ellipsometer, were n (193 nm)=1.59, k (193 nm)=0.22.

### BARC FORMULATION EXAMPLE 4

An antireflective coating composition was prepared by dissolving 4 g of the polymer from Polymer Example 3, 0.08 g of triethylammonium salt of dodecylsulfonic acid in 100 g PGMEA/PGME 70:30 mixture. The solution was filtered through 0.2 pm filter. An aliquot of the filtered solution was spun onto an 8″ silicon wafer at 2500 rpm and the wafer was then baked at 200° C. for 90 seconds to give a film thickness of 70 nm (as measured on a J.A. Woollam VUV-Vase Ellipsometer, ModelVU-302). Optical constants, n and k, measured on the Ellipsometer, were n (193 nm)=1.81, k (193 nm)=0.13.

### BARC FORMULATION EXAMPLE 5

An antireflective coating composition was prepared by dissolving 4 g of the polymer from Polymer Example 4, 0.08 g of triethylammonium salt of dodecylsulfonic acid in 100 g PGMEA/PGME 70:30 mixture. The solution was filtered through 0.2 μm filter. An aliquot of the filtered solution was spun onto an 8″ silicon wafer at 2500 rpm and the wafer was then baked at 200° C. for 90 seconds to give a film thickness of 70 nm (as measured on a J.A. Woollam VUV-Vase Ellipsometer, ModelVU-302). Optical constants, n and k, measured on the Ellipsometer, were n (193 nm)=1.90, k (193 nm)=0.34.

### BARC FORMULATION EXAMPLE 6

An antireflective coating composition was prepared by dissolving 2.4 g of the polymer from Polymer Example 3, 1.6 g of the polymer from Polymer Example 4, 0.08 g of triethylammonium salt of dodecylsulfonic acid in 100 g PGMEA/PGME 70:30 mixture. The solution was filtered through 0.2 μm filter. An aliquot of the filtered solution was spun onto an 8″ silicon wafer at 2500 rpm and the wafer was then baked at 200° C. for 90 seconds to give a film thickness of 70 nm (as measured on a J.A. Woollam VUV-Vase Ellipsometer, ModelVU-302). Optical constants, n and k, measured on the Ellipsometer, were n (193 nm)=1.83, k (193 nm)=0.21.

### BARC FORMULATION EXAMPLE 7

An antireflective coating composition was prepared by dissolving 4 g of the polymer from Polymer Example 5, 0.08 g of triethylammonium salt of dodecylsulfonic acid in 100 g PGMEA/PGME 70:30 mixture. The solution was filtered through 0.2 pm filter. An aliquot of the filtered solution was spun onto an 8″ silicon wafer at 2500 rpm and the wafer was then baked at 200° C. for 90 seconds to give a film thickness of 70 nm (as measured on a J.A. Woollam VUV-Vase Ellipsometer, ModelVU-302). Optical constants, n and k, measured on the Ellipsometer, were n (193 nm)=1.73, k (193 nm)=0.59.

### LITHOGRAPHIC EVALUATION EXAMPLE 1

The solution prepared in BARC Formulation Example 3 was diluted with 100 g of ethyl lactate and coated on a thin layer of underlayer BARC AZ® EXP ArF-LD2 (available from AZ Electronic Materials, Somerville, N.J.) on silicon wafer and baked at 200° C. for 90 seconds. A 190 nm film AZ® EXP T83742 photoresist was coated and baked at 115° C. for 60 seconds on top of the diluted BARC Formulation Example 3 coating layer of the BARC stack. The wafer was then imagewise exposed using a Nikon NSR-306D (NA: 0.85) scanner. After a PEB of 130° C./60s, wafers were developed with a surfactant-free developer, AZ® 300MIF, containing 2.38% tetramethyl ammonium hydroxide (TMAH) for 30 seconds. The line and space patterns when observed under scanning electron microscope showed no standing waves, indicating an acceptable antireflective coating.

The foregoing description of the invention illustrates and describes the present invention. Additionally, the disclosure shows and describes only certain embodiments of the invention but, as mentioned above, it is to be understood that the invention is capable of use in various other combinations, modifications, and environments and is capable of changes or modifications within the scope of the inventive concept as expressed herein, commensurate with the above teachings and/or the skill or knowledge of the relevant art. The embodiments described hereinabove are further intended to explain best modes known of practicing the invention and to enable others skilled in the art to utilize the invention in such, or other, embodiments and with the various modifications required by the particular applications or uses of the invention. Accordingly, the description is not intended to limit the invention to the form disclosed herein. Also, it is intended that the appended claims be construed to include alternative embodiments.

1. An antireflective coating composition capable of forming a film and suitable for coating over a substrate, the antireflective coating composition comprising a resin mixture, the resin mixture comprising at least a first resin and a second resin, where the amounts of the first resin and the second resin are tuned so that the film formed by the antireflective coating composition has an index of refraction (n) which is within ±0.1 of an index of refraction (n) required by a customer or determined by simulation and an absorption parameter (k) which is within ±0.02 of an absorption parameter (k) required by a customer or determined by simulation.

2. The antireflective coating composition of claim 1 wherein the first resin and the second resin are each individually selected from a polyester and a polyether.

3. The antireflective coating composition of claim 2 which further comprises a crosslinking agent.

4. The antireflective coating composition of claim 2 wherein the polyester comprises at least one unit selected from 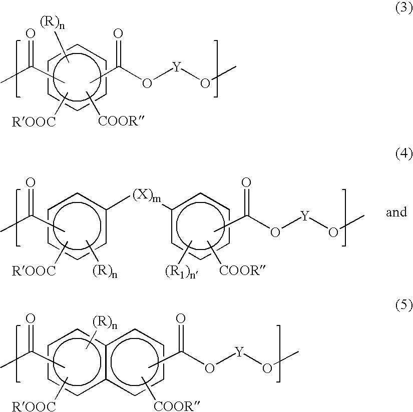
where Y is a hydrocarbyl linking group of 1 to about 10 carbon atoms, R, R₁, R′ and R″ are independently hydrogen, hydrocarbyl group of 1 to about 10 carbon atoms, halogen, —O(CO)Z, —C(CF₃)₂Z, —C(CF₃)₂(CO)OZ, —SO₂CF₃, —(CO)OZ, —SO₃Z, —COZ, —OZ, —NZ₂, —SZ, —SO₂Z, —NHCOZ, —NZCOZ or —SO₂NZ₂, where Z is H or a hydrocarbyl group of 1 to about 10 carbon atoms, n=1-4, n′=1-4, X is O, CO, S, COO, CH₂O, CH₂COO, SO₂, NH, NL, OWO, OW, WO, WOW, W, and where L is unsubstituted or substituted hydrocarbyl group and W is unsubstituted or substituted hydrocarbylene group, and m=0-3.

5. The antireflective coating composition of claim 4 wherein the hydrocarbyl is selected from the group consisting of substituted or unsubstituted linear or branched aliphatic (C₁₋₅₀) alkyl group, substituted or unsubstituted linear or branched aliphatic (C₁₋₅₀) alkylene group, substituted or unsubstituted linear or branched thio-alkylene aliphatic (C₁₋₅₀) group, substituted or unsubstituted cycloalkylene, substituted or unsubstituted benzyl, alkoxy alkylene, alkoxyaryl, substituted aryl, hetero cycloalkylene, heteroaryl, oxocyclohexyl, cyclic lactone, benzyl, substituted benzyl, hydroxy alkyl, hydroxyalkoxyl, alkoxy alkyl, alkoxyaryl, alkylaryl, alkenyl, substituted aryl, hetero cycloalkyl, heteroaryl, nitroalkyl, haloalkyl, alkylimide, alkyl amide, and mixtures thereof.

6. The antireflective coating composition of claim 4 where Y is selected from methylene, ethylene, propylene, butylene, phenylethylene, alkylnitroalkylene, dithiaoctylene, bromonitroalkylene, phenyl, naphthyl, and derivatives thereof.

7. The antireflective coating composition of claim 6 where Y is selected from 1-phenyl-1,2-ethylene, 2-bromo-2-nitro-1,3-propylene, 2-bromo-2-methyl-1,3-propylene, 3,6-dithio-1,8-octylene, —CH₂OCH₂—, —CH₂CH₂OCH₂CH₂—, —CH₂CH₂SCH₂CH₂—, or —CH₂CH₂SCH₂CH₂SCH₂CH₂—.

8. The antireflective coating composition of claim 2 wherein the polyester comprises at least one unit selected from 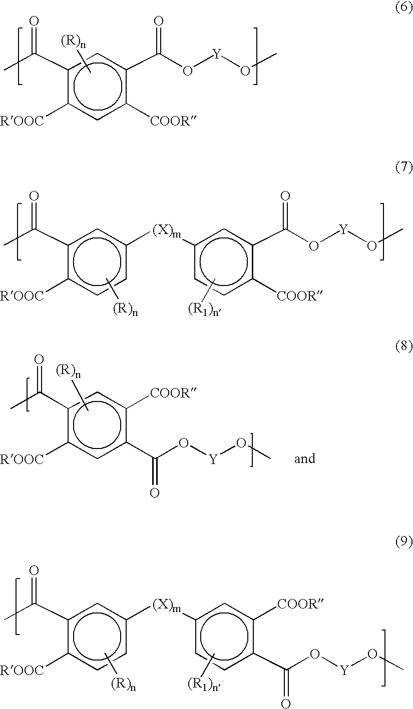
where Y is a hydrocarbyl linking group of 1 to about 10 carbon atoms, R, R₁, R′ and R″ are independently hydrogen, hydrocarbyl group of 1 to about 10 carbon atoms, halogen, —O(CO)Z, —C(CF₃)₂Z, —C(CF₃)₂(CO)OZ, —SO₂CF₃, —(CO)OZ, —SO₃Z, —COZ, —OZ, -NZ₂, —SZ, —SO₂Z, —NHCOZ, —NZCOZ or —SO₂NZ₂, where Z is H or a hydrocarbyl group of 1 to about 10 carbon atoms, n=1-4, n′=1-4, X is O, CO, S, COO, CH₂O, CH₂COO, SO₂, NH, NL, OWO, OW, WO, WOW, W, and where L is unsubstituted or substituted hydrocarbyl group and W is unsubstituted or substituted hydrocarbylene group, and m=0-3.

9. The antireflective coating composition of claim 2 wherein the polyether comprises a polymer obtained by reacting at least one glycoluril compound with at least one reactive compound containing at least one hydroxy group and/or one acid group.

10. The antireflective coating composition of claim 9 wherein the reactive compound contains 2 or more hydroxy groups or 2 or more acid groups.

11. The antireflective coating composition of claim 9 wherein the reactive compound contains a hydroxy group and/or an acid group.

12. The antireflective coating composition of claim 9 wherein the reactive compound is a mixture selected from a reactive compound containing 2 or more hydroxy or acid groups and a reactive compound containing a hydroxy group and/or an acid group.

13. The antireflective coating composition of claim 9 wherein the polyether contains a chromophore group.

14. The antireflective coating composition of claim 9 which comprises at least one unit of the structure

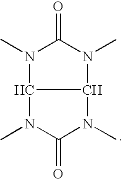

15. The antireflective coating composition of claim 9 wherein the reactive compound is selected from ethylene glycol, diethylene glycol, propylene glycol, neopentyl glycol, polyethylene glycol, hexane diol, butane diol, styrene glycol, polypropylene oxide, polyethylene oxide, butylenes oxide, 1-phenyl-1,2-ethanediol, 2-bromo-2-nitro-1,3-propane diol, 2-methyl-2-nitro-1,3-propanediol, diethylbis(hydroxymethyl)malonate, hydroquinone, 3,6-dithia-1,8-octanediol, Bisphenol A, 2,6-bis(hydroxymethyl)-p-cresol, 2,2′-(1,2-phenylenedioxy)-diethanol, 1,4-benzenedimethanol, phenylsuccinic acid, benzylmalonic acid, 3-phenylglutaric acid 1,4-phenyldiacetic acid, oxalic acid, malonic acid, succinic acid, pyromellitic dianhydride, 3,3′,4,4′-benzophenone-tetracarboxylic dianhydride, naphthalene dianhydride, 2,3,6,7-naphthalenetetracarboxylic acid dianhydride, 1,4,5,8-naphthalenetetracarboxylic acid dianhydride, 3-hydroxyphenylacetic acid, 2-(4-hydroxyphenoxy)propionic acid phenol, o-cresol, 2-ethoxyphenol, p-methoxyphenol, m-cresol, 4-ethylphenol, 4-propylphenol, 4-fluorophenol, 2,3-dimethoxyphenol, 2,6-dimethylphenol, 2,4-dimethylphenol, 3,4,5-trimethylphenol, 1-naphthol, 2-naphthol, 4-methoxy-1-naphthol, 2-phenylphenol, 4-(benzyloxy)phenol, benzyl alcohol, 2-methylbenzyl alcohol, 2-methoxybenzyl alcohol, 3-methylbenzyl alcohol, 3-(trifluromethyl)benzyl alcohol, 4-ethylbenzyl alcohol, 4-ethoxybenzyl alcohol, 4-(trifluromethoxy)benzyl alcohol, 3,5-diflurobenzyl alcohol, 2,4,5-trimethoxybenzyl alcohol, 4-benzyloxybenzyl alcohol, 1-naphthalenethanol, 2-phenyl-1-propanol, 2,2-diphenylethanol, 4-phenyl-1-butanol, 2-phenoxyethanol, 4-methoxyphenethyl alcohol, 2-hydroxybenzophenone, phenylacetic acid, 1-naphthylacetic acid, and mixtures thereof.

16. The antireflective coating composition of claim 3, where the crossilinking agent is selected from tetramethylol glycoluril, tetrabutoxymethyl glycoluril, tetramethoxymethyl glycoluril, partially methoylated glycoluril, tetramethoxymethyl glycoluril, dimethoxymethyl glycoluril, mono- and dimethylether of dimethylol glycoluril, trimethylether of tetramethylol glycoluril, tetramethylether of tetramethylol glycoluril, tetrakisethoxymethyl glycoluril, tetrakispropoxymethyl glycoluril, tetrakisbutoxymethyl glycoluril, tetrakisamyloxymethyl glycoluril, tetrakishexoxymethyl glycoluril, and mixtures thereof.

17. The antireflective coating composition of claim 9 where the polyether further comprises a chromophore group.

18. The antireflective coating composition of claim 17, where the chromophore group is selected from an aromatic group and hetroaromatic group.

19. The antireflective coating composition of claim 18, where the chromophore group is selected from a phenyl group, a substituted phenyl group, a naphthyl group, a substituted naphthyl group, an anthracyl group and a substituted anthracyl group.

20. The antireflective coating composition of claim 1 wherein the first resin is a polyester and the second resin is a polyether.

21. The antireflective coating composition of claim 1 wherein the first resin and the second resin are both polyether.

22. The antireflective coating composition of claim 1 wherein the first resin is a polyether and the second resin is a polyester.

23. The antireflective coating composition of claim 1 wherein the first resin and the second resin are both polyester.

24. The antireflective coating composition of claim 23 which further comprises a crosslinking agent.

25. A coated substrate comprising a substrate having thereon: a layer of the composition of claim 1; and a layer of a chemically-amplified photoresist composition above said layer of the composition of claim 1.

26. A method for forming a photoresist relief image comprising: applying on a substrate a layer of the composition of claim 1; and applying a layer of chemically-amplified photoresist composition above said composition of claim 1.

27. A method for tuning an index of refraction (n) and an absorption parameter (k) of an antireflective coating composition capable of forming a film and suitable for coating over a substrate comprising obtaining index of refraction (n) and absorption parameter (k) required by a customer or determined by simulation; obtaining at least a first resin; adding to said first resin a second resin to form the antireflective coating composition, the second resin being added in sufficient quantity so that the film formed by the antireflective coating composition has an index of refraction (n) which is within ±0.1 of the index of refraction (n) required by a customer or determined by simulation and an absorption parameter (k) which is within ±0.02 of the absorption parameter (k) required by a customer or determined by simulation.

28. The method of claim 27 wherein the first resin is a polyester and the second resin is a polyether.

29. The method of claim 28 wherein the antireflective coating composition further comprises a crosslinking agent.

30. The method of claim 27 wherein the first resin and the second resin are both polyether.

31. The method of claim 27 wherein the first resin and the second resin are both polyester.

32. The method of claim 31 wherein the antireflective coating composition further comprises a crosslinking agent.
